(19) United States
(12) Patent Application Publication
(10) Pub. No.: US 2008/0101904 A1
(43) Pub. Date: May 1, 2008

(54) HMA AUGER SYSTEM WITH CENTER STRIPE REDUCING DUAL OUTBOARD AUGER DRIVES

(75) Inventor: JOSEPH E. MUSIL, ELY, IA (US)

Correspondence Address: SIMMONS PERRINE PLC, THIRD FLOOR TOWER PLACE, 22 SOUTH LINN STREET, IOWA CITY, IA, 52240, US

(73) Assignee: CEDARAPIDS, INC., CEDAR RAPIDS, IA (US)

(21) Appl. No.: 11/874,718

(22) Filed: Oct. 18, 2007

Related U.S. Application Data
(60) Provisional application No. 60/862,872, filed on Oct. 25, 2006.

(51) Int. Cl. B60P 1/40

(52) U.S. Cl. 414/526

(57) ABSTRACT

An HMA distribution system on the rear of a piece of road building equipment which does not have a center support or at least does not have a wide center drive chain region which causes a center striping problem, instead the two inboard augers are driven from motors on opposite ends of the distribution system. Additionally, optional outboard augers are used to move material further outward from drive motors.

### FIELD OF THE INVENTION

The present invention generally relates to road paving equipment, and more particularly relates to machines with a capability for transporting and handling hot mix asphalt (HMA) material.

### BACKGROUND OF THE INVENTION

In the past, road paving equipment designers have endeavored to improve the functionality of road paving equipment. FIG. 1 shows an example of a prior art HMA distribution system which includes back paddles to move the HMA in a short reverse direction, to bring HMA toward the relatively wide central zone without an auger of any type.

While these approaches of using back paddles have been used extensively in the past, they do have some drawbacks. For example, the back paddle must be sized, configured and operated precisely so the requisite force to move the HMA toward the center region is provided without providing too much and overloading the central area with HMA. In some situations, the back paddles cause the center striping to be less pronounced, but over a wider area.

Consequently, there exists a need for improved methods and systems for distributing HMA outwardly with a pair of opposing augers while reducing any center striping.

### SUMMARY OF THE INVENTION

It is an object of the present invention to provide a system and method for distributing HMA in an efficient manner.

It is a feature of the present invention to utilize a pair of outboard driven augers.

It is an advantage of the present invention to reduce the width of structure disposed between the two opposing augers.

It is another advantage to permit a reduction in center striping.

The present invention is an apparatus and method for distributing HMA which is designed to satisfy the aforementioned needs, provide the previously stated objects, include the above-listed features, and achieve the already articulated advantages. The present invention is carried out in a “center stripe-less” manner in a sense that center stripe in the asphalt corresponding to the gap between the augers has been greatly reduced or even in some cases, eliminated.

Accordingly, the present invention is a system and method including a piece of road building equipment with an HMA distribution system of two opposing augers which are driven from outboard positions.

### BRIEF DESCRIPTION OF THE DRAWINGS

The invention may be more fully understood by reading the following description of the preferred embodiments of the invention, in conjunction with the appended drawings wherein:

FIG. 1 is a view of a prior art system having a relatively wide gap between the two opposing augers.

FIG. 2 is a view of one embodiment of the present invention which has dual augers which are driven from outboard drives.

### DETAILED DESCRIPTION

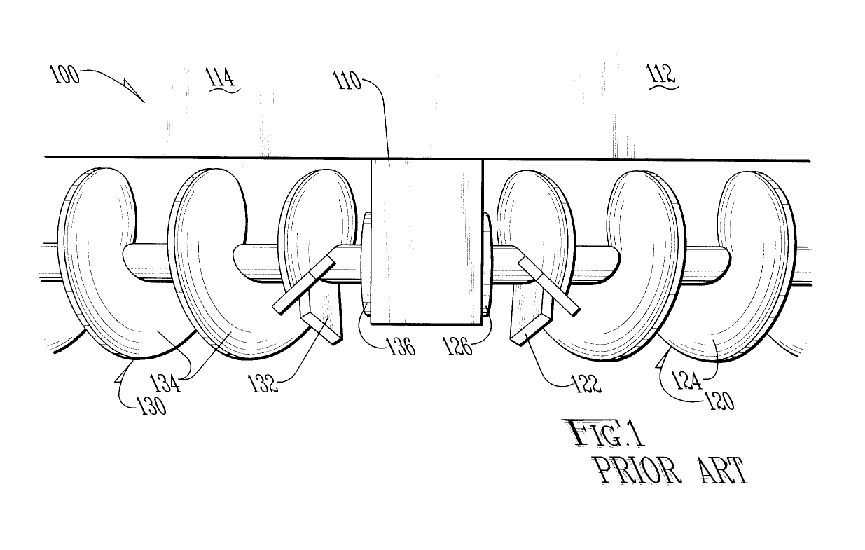

Now referring to the drawings wherein like numerals refer to like matter throughout, and more specifically referring to FIG. 1, there is shown an HMA distribution system of the prior art, generally designated 100, which includes a central support and drive structure 110, a first auger 120 and a second auger 130. First auger 120 includes a first auger back paddle 122, a first auger forward fluke 124, and a first auger central support point 126. Second auger 130 includes a second auger back paddle 132, a second auger forward fluke 134, and a second auger central support point 136. Also shown are first HMA slide area 112 and second HMA slide area 114. In some situations, the central support and drive structure in combination with the first auger back paddle 122 and the second auger back paddle 132 may create a center striping in the finished pavement product owing to uneven distribution of the HMA.

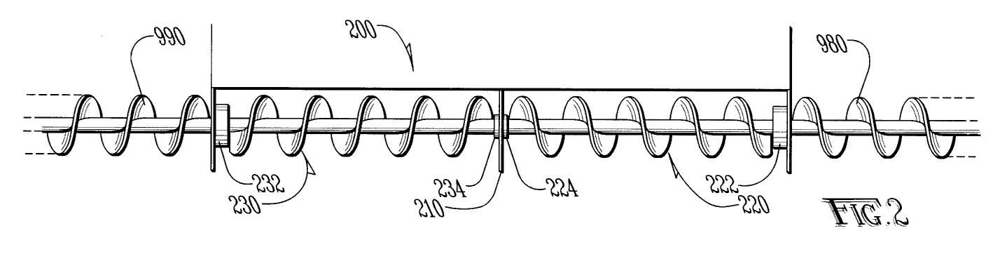

Now referring to FIG. 2, there is shown one embodiment of an HMA distribution system, generally designated 200, of the present invention which includes a first auger 220, a second auger 230 and a narrow central support 210 (optional). First auger 220 is shown having a first auger end driver 222 and a central connection point 224. Second auger 230 is shown having a second auger end driver 232 and a central connection point 234. The narrow central support 210 is not a drive mechanism for either of the augers. It merely is a support structure. It is believed that this narrow structure in combination with the lack of need for and inclusion of back paddles results in a diminished tendency for center striping to occur in the final road surface. It is also possible to build sufficient strength into the first auger 220 and the second auger 230 that the need for the central support 210 could be eliminated. A shaft and suitable bearing would connect each auger inner end and support it, but allow for independent freedom of rotation of each auger.

When paving widths greater than the distance between first auger driver 222 and second auger driver 232, it is to be understood that additional auger sections such as 980 and 990 can be added outboard of or beyond the drivers 222 and 232.

Throughout the above description, HMA is described as the material to be used. It should be understood that the present invention is directed to any type of road surface. It is believed that recycled asphalt products could be used, cold mix asphalt, and even in certain applications with any appropriate modifications, concrete could be the paving material. The term “road building material(s)” as used herein shall be construed to include all of the following: HMA, cold mix asphalt, recycled asphalt products, and concrete.

It is thought that the method and apparatus of the present invention will be understood from the foregoing description and that it will be apparent that various changes may be made in the form, construct steps, and arrangement of the parts and steps thereof, without departing from the spirit and scope of the invention or sacrificing all of their material advantages. The form herein described is merely a preferred exemplary embodiment thereof.

I claim:

1. A hot mix asphalt distribution system comprising:
a vehicle configured to transport road building material;
a first auger disposed on a first side of a support line, the first auger configured to move the road building material which has been transported on the vehicle, toward a first end when the first auger is rotated around a first longitudinal axis;
a second auger disposed on a second side of the support line, the second auger configured to move the road building material toward a second end when the second auger is rotated around a second longitudinal axis; and
the second end is opposite the first end.

2. The hot mix asphalt distribution system of claim 1 further comprising a central support structure disposed at the support line, configured to support an inside end of the first auger and an inside end of a second auger; the central support structure being free of any fixed attachment to any drive motors which are configured to rotate one of the first auger and the second auger about a longitudinal axis, wherein the first auger is free of any paddles thereon which are configured to move the road building material in a direction away from the first end.

3. The system of claim 2 wherein the second auger is free of any paddles thereon which are configured to move the road building material in a direction away from the second end.

4. The system of claim 3 further comprising a first drive motor coupled to the first auger.

5. The system of claim 4 further comprising a second drive motor coupled to the second auger.

6. The system of claim 4 wherein the first longitudinal axis is collinear with the second longitudinal axis.

7. The system of claim 6 wherein the first auger and the second auger are coupled such that rotation of one results in an equivalent rotation of another.

8. The system of claim 1 further comprising a first drive motor coupled to the first auger.

9. The system of claim 8 further comprising a second drive motor coupled to the second auger.

10. The system of claim 8 wherein the first longitudinal axis is collinear with the second longitudinal axis.

11. The system of claim 10 wherein the first auger and the second auger are coupled such that rotation of one results in an equivalent rotation of another.

12. The system of claim 1 wherein:
the first end is open;
the second end is open;
a first outboard auger which is selectively and readily detachably coupled to a first drive motor which provides support to and drives the first auger; the first outboard auger configured to move material outwardly beyond the first drive motor; and,
a second outboard auger which is selectively and readily detachably coupled to a second drive motor which provides support to and drives the second auger; the second outboard auger configured to move material outwardly beyond the second drive motor;

13. A road building material distribution system comprising:
a vehicle for transporting road building material;
a first means for moving road building material from a central location to a first non-central location;
a first means for driving, from the first non-central location, the first means for moving;
a second means for moving road building material from the central location to a second non-central location; and
a second means for driving, from the second non-central location, the second means for moving.

14. The system of claim 13 wherein the distance between the first non-central location and the central location is substantially the same as the distance from the second non-central location to the central location.

15. The system of claim 14 wherein the first means for moving and the second means for moving each comprise augers and a connection to a center support structure.

16. The system of claim 15 wherein each auger comprises a central shaft without a reverse flow inducing back paddle thereon.

17. A method of distributing HMA comprising the steps of:
providing a pair of adjacent augers disposed in opposition to each other;
where each auger is driven from the distal end by a drive motor which operates an auger; and
causing the pair of adjacent augers to move road building materials in opposing directions.

18. The method of claim 17 further comprising the steps of:
providing a central support member to support a non-driven end of each auger;
wherein each auger is driven by a drive motor which drives only one auger.

19. The method of claim 17 further comprising the steps of:
providing a pair of outboard augers each of which is coupled to a drive motor which operates one of the pair of augers and each of the pair of outboard augers being configured to move materially away from the pair of augers.
